(19) United States
(12) Patent Application Publication
(10) Pub. No.: US 2024/0182055 A1
(43) Pub. Date: Jun. 6, 2024

(54) Method for Operating an Assistance System of a Vehicle With Proactive Suggestion for Carrying Out an Assistance Function, Assistance System, and Vehicle

(71) Applicant: Bayerische Motoren Werke Aktiengesellschaft, Muenchen (DE)

(72) Inventors: Yannick FORSTER, Muenchen (DE); Hubert SCHOLZ, Muenchen (DE); Martin SEDLMAYR, Wessobrunn (DE)

(21) Appl. No.: 18/287,691

(22) PCT Filed: Mar. 23, 2022
(86) PCT No.: PCT/EP2022/057604

§ 371 Date: Oct. 20, 2023

(30) Foreign Application Priority Data
Apr. 22, 2021 (DE) 10 2021 110 348.7

(51) Int. Cl. B60W 50/14; B60W 30/18; B60W 40/09

(52) U.S. Cl. CPC B60W 50/14; B60W 30/18036; B60W 40/09; B60W 2540/215; B60W 2554/4045; B60W 2554/4046; B60W 2556/10; B60W 2556/40

(57) ABSTRACT

A method for operating an assistance system of a vehicle includes recording a trajectory along which the vehicle was manually maneuvered by a driver in the forward travel direction, receiving data describing an environment of the vehicle and/or behavior of at least one additional road user, recognizing a dead-end situation based on the received data, suggesting carrying out a reversing function, wherein the vehicle is maneuvered along the recorded trajectory in the reverse travel direction, in dependence on the recognized dead-end situation, and carrying out the reversing function by means of the assistance system if the suggestion is accepted by the driver.

### BACKGROUND AND SUMMARY

The present invention relates to a method for operating an assistance system of a vehicle with proactive suggestion for performing an assistance function. Additionally, the present invention relates to an assistance system for a vehicle and to a vehicle having such an assistance system.

The prior art discloses various driver assistance systems or assistance systems for assisting a driver or user during operation of the vehicle. By way of example, assistance functions are known in which a path or trajectory taken is recorded and the vehicle can subsequently be maneuvered along the recorded trajectory in an automated or autonomous manner. In addition, the prior art discloses assistance functions that also log reference points or objects in the surroundings when recording the path. When travelling along the recorded trajectories in an automated manner, these logged reference points can be used as so-called landmarks in order to localize the vehicle.

In this context, the prior art discloses so-called reverse assist systems or backtracking assist systems. Such a reverse assist system can be used to provide a reversing function in which the vehicle is maneuvered along the previously covered path in the opposite direction of travel in an automated manner. In order to be able to maneuver the vehicle in the opposite direction of travel, previously recorded surroundings data or reference data can also be used. By way of example, this assistance function can be useful in parking situations, but additionally also when the vehicle is intended to be reversed in narrow lanes.

In this regard, DE 10 2016 224 368 A1 describes a driver assistance system for automated maneuvering using automated lateral and/or longitudinal guidance for a motor vehicle. The driver assistance system is configured so as, as part of a first operating mode, to record a route taken manually by the driver with the motor vehicle. The driver assistance system is also configured so as then, as part of a second operating mode, to take the recorded route as a basis for maneuvering the vehicle to the start of the recorded route using automated lateral and/or longitudinal guidance, for example—as in the case of a reversing assistance system—from the end of the recorded route to the start thereof in the reverse direction.

It is an object of the present invention to demonstrate a solution that can make it easier for a driver of a vehicle to use an assistance system for providing a reversing function. A vehicle having such an assistance system is also intended to be provided.

This object is achieved according to the invention by a method, by an assistance system and by a vehicle having the features according to the present disclosure. Advantageous developments of the present invention are also specified in the present disclosure.

A method according to the invention is used for operating an assistance system of a vehicle. The method comprises recording a trajectory along which the vehicle has been maneuvered in the forward direction of travel manually by a driver. In addition, the method comprises receiving data that describe surroundings of the vehicle and/or a behavior of at least one other road user in the surroundings. The method also comprises suggesting performance of a reversing function in which the vehicle is maneuvered along the recorded trajectory in the reverse direction of travel. Moreover, the method comprises performing the reversing function by means of the assistance system if the suggestion is accepted by the driver. The method is characterized by detecting a dead-end situation on the basis of the received data, the dead-end situation describing a situation in which passage of the vehicle is temporarily not possible and/or not permitted in the forward direction of travel. In addition, the method comprises suggesting performance of the reversing function on the basis of the detected dead-end situation.

The assistance system is intended to be used to provide the driver of the vehicle with a reversing function. To facilitate this reversing function, the trajectory along which the vehicle is maneuvered is first recorded. By way of example, this trajectory can be recorded in a first operating mode or during a so-called learning phase. While the trajectory is being recorded, the vehicle can be manually maneuvered by the driver. During the manual maneuvering, the driver can operate the steering wheel, the gas pedal and/or the brake pedal himself. During the learning phase, reference data or landmarks can also be acquired and stored. The landmarks used can be appropriate objects in the surroundings that are recorded using an environment sensor of the vehicle, for example a camera. During the learning phase, odometry data can also be recorded. These odometry data can describe the movement of the vehicle. In particular, the odometry data can describe the number of revolutions of at least one wheel of the vehicle and a steering angle or a yaw rate of the vehicle. The odometry data can also describe the position, the orientation and the driving state of the vehicle at specific times.

When the reversing function is being performed, the vehicle can be maneuvered along the previously recorded trajectory by means of the assistance system in an automated or autonomous manner. The vehicle may be able to orient or localize itself using the landmarks recorded in the learning phase. During the maneuvering along the recorded trajectory, the vehicle or the assistance system of the vehicle can undertake the longitudinal guidance and/or the lateral guidance of the vehicle.

In addition, the data are received during operation of the vehicle or the assistance system. The data can firstly describe the surroundings of the vehicle. By way of example, the data can describe appropriate objects, the road or the like in the surroundings. Additionally, the data can describe the behavior of at least one other road user in the surroundings. These data can be acquired using appropriate sensors of the vehicle. Additionally, the data can be transmitted to the vehicle by a device outside the vehicle.

According to the present invention, there is now provision for these received data to be taken as a basis for detecting a so-called dead-end situation. The dead-end situation in this case describes a situation in which passage is temporarily or currently not possible and/or not permitted for the vehicle in the forward direction of travel. In other words, the dead-end situation can describe a situation in which it is currently not possible for the vehicle to continue to travel in the forward direction of travel. This may be the case for example if the vehicle is in a lane without additional forking that allows the vehicle to turn. Similarly, such a dead-end situation can arise when the vehicle has been maneuvered along a winding and/or narrow approach road. Moreover, the dead-end situation can arise when for example passage is temporarily blocked for the vehicle, for example by another road user or the like. The dead-end situation can also arise when passage of the vehicle is currently not permitted in the forward direction of travel. This can arise due to a road closure, a barrier due to roadworks or the like.

When a dead-end situation of this kind is detected, the driver can now be proactively offered performance of the reversing function. In other words, there is now provision for the suggestion to be made according to the situation and for the driver to agree to the suggestion by way of an appropriate control input. By comparison, there is provision according to the prior art for the driver to have to actively select the function and to possibly have to search a menu in this regard. It may also be the case that the driver does not know that there is such a reversing function in the vehicle. Overall, it is therefore possible to make it easier for the driver to use the assistance system used to provide the reversing function.

Preferably, the received data that describe the surroundings of the vehicle are environmental data from at least one environment sensor of the vehicle. The vehicle or the assistance system can comprise one or more environment sensors, which may be in the form of radar sensors, lidar sensors, laser scanners, cameras or ultrasonic sensors, for example. These environment sensors can be used to provide the environmental data and for example to transmit them to a computing device of the assistance system. This computing device can be used to evaluate the environmental data as appropriate. By way of example, the environmental data can describe a road sign indicating a dead-end street or bottleneck. The environmental data can also describe the physical dimensions of a road that the vehicle is currently on. This allows a dead-end street or a bottleneck to be detected, for example.

The environmental data can also be taken as a basis for detecting static and/or dynamic objects currently blocking passage for the vehicle in the forward direction of travel. The environmental data provided using the environment sensors of an assistance system that are normally used can therefore be used to detect the dead-end situation.

In a further embodiment, the received data that describe the surroundings of the vehicle are high-resolution map data. In order to be able to detect the dead-end situation, high-resolution map data or so-called HD maps can alternatively or additionally also be used. These high-resolution map data can be used to detect permanent bottlenecks within the road and/or dead-end streets. These high-resolution map data can include very accurate information about the dimensions or the width of the road that the vehicle is currently on. The high-resolution map data can also include information relating to traffic regulations and/or road signs. Use of the high-resolution map data allows the dead-end situation to be reliably detected.

Additionally, map data having a lower resolution can also be used if dead-end streets and/or bottlenecks are shown therein. Alternatively or additionally, the vehicle position can also have lower accuracy. By way of example, it may already suffice for detecting the dead-end situation to localize the vehicle in a specific road that is deposited in the map data with a lower resolution than a dead-end street.

It is furthermore advantageous if the data that describe a behavior of at least one other road user characterize a current driving maneuver and/or a driving intention of the at least one other road user. In other words, these data can describe the current traffic circumstances in the surroundings of the vehicle or in a surrounding area in the forward direction of travel ahead of the vehicle. The other road user may be a truck, a waste collection vehicle or the like, for example, that is currently blocking passage for the ego vehicle. The data can also describe a vehicle coming toward the ego vehicle from the opposite direction on a narrow road or in a narrow lane.

The data can also describe the driver's intention of the at least one other road user. This driver's intention can be used to infer whether or not the other road user wants to allow the vehicle to pass, for example. The data can also describe signals provided by the other road user, for example a headlight flash or a hand signal. These signals can then be used to infer the driver's intention. The dead-end situation can therefore be ascertained on the basis of the behavior of the at least one other road user in the surroundings of the vehicle.

In a further embodiment, the data that describe a behavior of at least one other road user describe information relating to a driving maneuver performed by the at least one other road user in the past and/or a reversing function performed by the at least one other road user in the past. In other words, other vehicles or road users or the vehicles of a fleet can be used as a “sensor”. If these other road users sense a bottleneck or a dead-end street, for example, this information relating to a dead-end street or bottleneck can be transmitted to an external data memory or to a backend. There, a map layer can be enriched with this information and in turn made available to other vehicles or the vehicles of the fleet. This allows consideration to be given to the historical behavior of other road users in the same traffic situation.

Additionally, the data can describe whether the reversing function has already been used previously by other road users or road users of the fleet in the area that the vehicle is currently in. In other words, it is possible to check whether drivers have already used the reversing function previously at this location. The information about the usage of the reversing function can likewise be transmitted to the external memory device or the backend by the vehicle and be received and used by other road users.

As outlined previously, different data that describe the surroundings of the vehicle and/or the behavior of other road users can be used to detect the dead-end situation. There may also be provision for these different data or data that come from different sources to be appropriately fused with one another. There may moreover be provision for the data that come from the different sources or describe the surroundings and/or the road users to be appropriately weighted. In particular, the knowledge learnt about the historical behavior of road users or about the use of the reversing function can be used in this case. If for example the environment sensors of the vehicle do not clearly detect a dead-end street, but a certain percentage, for example 10%, 50% or 90%, of road users in this situation have used the reversing function, this can be used as sufficient indication of the presence of the dead-end situation. In this case, the reversing function can be proactively offered or suggested to the driver.

If the dead-end situation is detected, then it can also be assumed with a relatively high probability that the driver requires assistance. Moreover, when the dead-end situation is present, it can be assumed that the vehicle is subsequently intended or needs to be moved in the reverse direction of travel. If the suggestion for the reversing function is output when the dead-end situation is present, the driver can also be offered this function only when he actually needs it.

In addition, the dead-end situation can be detected in the surroundings of the vehicle and/or on the basis of the maneuvers performed by the driver previously. If the driver maneuvers the vehicle into a parking space in the forward direction of travel, for example, and parks it there, it can be assumed that he wishes to maneuver the vehicle out of the parking space in the reverse direction of travel after parking. The driver can be proactively offered performance of the reversing function in the case of this dead-end situation too.

In a further embodiment, a current behavior of the driver is characterized and performance of the reversing function is additionally suggested on the basis of the characterized behavior. By way of example, the current behavior of the driver can be detected using an appropriate interior sensor system, for example a camera. Moreover, operation of the steering wheel and the brake pedal and/or the gas pedal by the driver can be sensed in order to characterize the current behavior of the driver. If the driver does not perform a driving maneuver for the time being or for a specific period of time when a dead-end situation has been detected, it can be inferred from this that the driver requires assistance. In this context, the data from the interior camera can also be used to be able to assess the current reaction of the driver. In principle, it is thus possible to suggest the reversing function to the driver if it can be assumed that he wants to be assisted.

Moreover, there is preferably provision for performance of the reversing function to be offered or suggested to the driver before he performs a manual driving maneuver himself. By way of example, the suggestion can be made before the driver maneuvers the vehicle manually in the reverse direction of travel. The suggestion can also be made before the driver selects reverse gear. The driver can therefore be offered assistance at the time at which he actually needs assistance.

In a further embodiment, an individual driving ability of the driver is determined on the basis of driving maneuvers manually performed by the driver to date and performance of the reversing function is additionally suggested on the basis of the individual driving ability. By way of example, the individual driving ability of the driver can describe whether he frequently or gladly drives the vehicle manually in the reverse direction of travel and/or only rarely uses assistance from an assistance system. In particular, the individual driving ability can describe whether the driver parks the vehicle in a parking space himself without using a park assist system or the like. The individual parking ability can be ascertained as a result of operation of the steering wheel, the brake pedal and/or the gas pedal by the driver. The proactive suggestion of the reversing function can therefore be individually matched to the driver or the driving ability thereof.

It is furthermore advantageous if performance of the reversing function is additionally suggested on the basis of a usage of this reversing function by the driver to date. By way of example, suggestion of the reversing function may be coupled to a user history. In this case, it is moreover possible to produce a personalized threshold on the basis of the quality from previous instances of reversing. By way of example, a threshold for the offer regarding the difficulty of situation from which the reversing function is proactively suggested can therefore be ascertained. It may also be the case that the reversing function is offered to the driver because he has not yet activated or made use of the reversing function to date. This may be the case for example if the driver has recently purchased the vehicle. The driver can therefore be informed that the assistance system can provide this function.

An assistance system according to the invention for a vehicle is configured to carry out a method according to the invention and the advantageous embodiments thereof. The assistance system can comprise one or more environment sensors that can be used to provide environmental data describing the surroundings of the vehicle. Additionally, the assistance system can comprise a computing device, which may be formed by at least one electronic control unit, for example. Moreover, the assistance system can comprise a communication unit that can be used to receive data from an external data memory or a backend or a cloud. The computing device can be used to evaluate these data as appropriate, and the dead-end situation or the bottleneck can therefore be detected. The computing device can additionally also receive appropriate high-resolution map data for this purpose. These high-resolution map data can be received from an external memory device and/or may be deposited in a data memory of the vehicle.

Moreover, the assistance system can comprise a satellite-assisted locating system, for example GPS. The satellite-assisted locating system can be used to determine the current position of the vehicle. Furthermore, the assistance system can comprise a unit for providing odometry data. The odometry data can be taken as a basis for recording the trajectory.

A further aspect of the invention relates to a computer program comprising instructions that, when the program is executed by a computing device of an assistance system, cause said assistance system to carry out a method according to the invention or parts of said method. In addition, the invention relates to a computer-readable (storage) medium comprising instructions that, when executed by a computing device of an assistance system, cause said computing device to carry out a method according to the invention or parts of said method.

A vehicle according to the invention comprises an assistance system according to the invention. The vehicle may in particular be in the form of a passenger vehicle.

The preferred embodiments presented with regard to the method according to the invention, and the advantages of said embodiments, apply accordingly to the assistance system according to the invention, to the vehicle according to the invention, to the computer program according to the invention and to the computer-readable (storage) medium according to the invention.

Further features of the invention will emerge from the claims, the figures and the description of the figures. The features and combinations of features cited in the description above, and the features and combinations of features cited in the description of the figures below and/or shown in the figures alone, can be used not only in the respectively indicated combination but also in other combinations or on their own without departing from the scope of the invention.

The invention will now be explained in more detail on the basis of preferred exemplary embodiments and with reference to the appended drawings.

### BRIEF DESCRIPTION OF THE DRAWINGS

FIG. 1 shows a schematic representation of a vehicle that comprises an assistance system for providing a reversing function;

FIG. 2 shows the vehicle shown in FIG. 1, which is in a dead-end street; and

FIG. 3 shows the vehicle shown in FIG. 1 in another traffic situation, in which a truck is in the lane of the vehicle.

### DETAILED DESCRIPTION OF THE DRAWINGS

In the figures, identical or functionally identical elements are provided with the same reference signs.

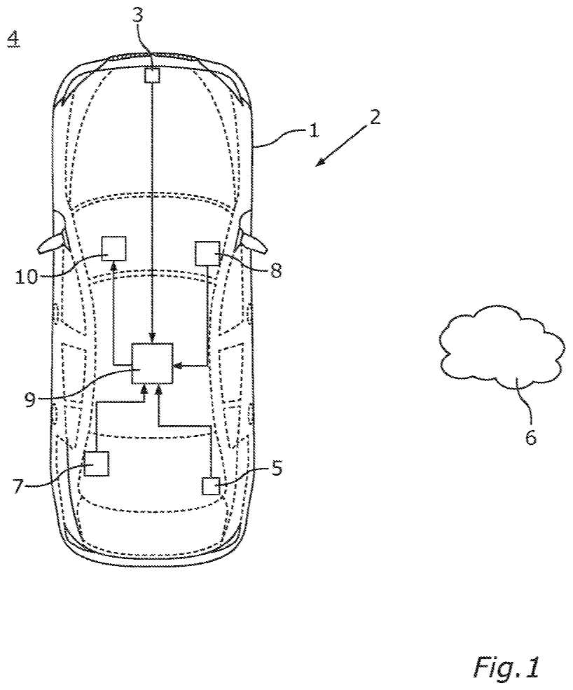

FIG. 1 shows a schematic representation of a vehicle 1, which is in the form of a passenger vehicle, in a plan view. The vehicle 1 comprises an assistance system 2. The assistance system 2 can be used to provide a reversing function, as described below.

The assistance system 2 comprises an environment sensor 3, which may be in the form of a camera, lidar sensor or radar sensor, for example. In the present example, the environment sensor 3 is in the form of a camera. The environment sensor 3 can be used to provide environmental data that describe surroundings 4 of the vehicle 1. The assistance system 2 additionally comprises a communication unit 5 that can be used to receive data. The communication unit 5 can be used to receive data from a backend 6 outside the vehicle 1. The data received from the backend 6 can describe the behavior of other road users 17 in the surroundings 4. By way of example, these data can describe the behavior of other road users 17 at specific positions. Moreover, these data can describe the usage behavior for assistance systems of the other road users 17.

Furthermore, the assistance system 2 comprises a satellite-assisted locating system 7. The satellite-assisted locating system 7 provides data that describe the current position of the vehicle 1. The assistance system 2 additionally comprises a unit 8 that provides odometry data. The odometry data can describe at least the speed of a wheel and/or the steering angle of the vehicle 1.

The assistance system 2 comprises a computing device 9 that is formed by at least one electronic control unit. The computing device 9 is connected to the environment sensor 3, the unit 8, the communication unit 5 and the satellite-assisted locating system 7 for data processing purposes. The data transmitted to the computing device 9 from the environment sensor 3, the communication unit 5 and the satellite-assisted locating system 7 can be taken as a basis for using the computing device 9 to infer a dead-end situation. This dead-end situation describes the case in which the vehicle 1 currently cannot or is not permitted to be moved in the forward direction of travel. If a dead-end situation is detected by the computing device 9, an output unit 10 can be used to output a suggestion to perform the reversing function to the driver of the vehicle 1. This suggestion can be made audibly, visually and/or haptically.

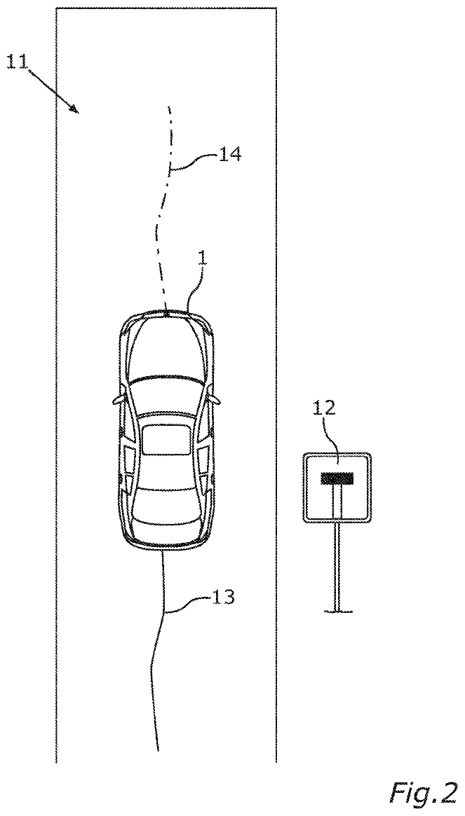

FIG. 2 shows the vehicle 1 shown in FIG. 1 in a first traffic situation. The vehicle 1 is in a dead-end street 11 in this case. In the example, there is a dead-end situation. This means that passage of the vehicle 1 is not possible in the forward direction of travel owing to the dead-end street 11. The presence of this dead-end situation can be detected on the basis of the environmental data provided using the environment sensor 3. These environmental data, which describe a road sign 12, inter alia, for example, can be taken as a basis for using the computing device 9 to infer a dead-end street 11. Moreover, the environmental data from the environment sensor 3 can be taken as a basis for detecting the dead-end street 11 on the basis of the end of the road.

When this dead-end situation has been detected, the driver of the vehicle 1 can be offered the reversing function performed using the assistance system 2. To facilitate this reversing function, the assistance system 2 is used to continually record a trajectory 13. The trajectory 13 can be recorded using the odometry data provided using the unit 8. Furthermore, there may be provision for appropriate landmarks to be recorded in the surroundings 4 of the vehicle on the basis of the environmental data from the environment sensor 3. The trajectory 13 can be continually recorded for a predetermined path length, which may be 50 m or 200 m, for example. The journey by the vehicle 1 within the dead-end street 11 is shown in the present case. The vehicle 1 is subsequently maneuvered to the end of the dead-end street 11. The further course of the trajectory 13 is illustrated schematically by the line 14 in the present case.

As soon as the vehicle 1 has reached the end of the dead-end street 11, the driver of the vehicle 1 can be offered the reversing function. If the driver confirms performance of the reversing function, said reversing function can be performed by the assistance system 2. This can be accomplished by maneuvering the vehicle 1 along the previously recorded trajectory 13 in the reverse direction of travel by means of the assistance system 2. The assistance system 2 can undertake the longitudinal guidance and/or the lateral guidance of the vehicle 1 in this case.

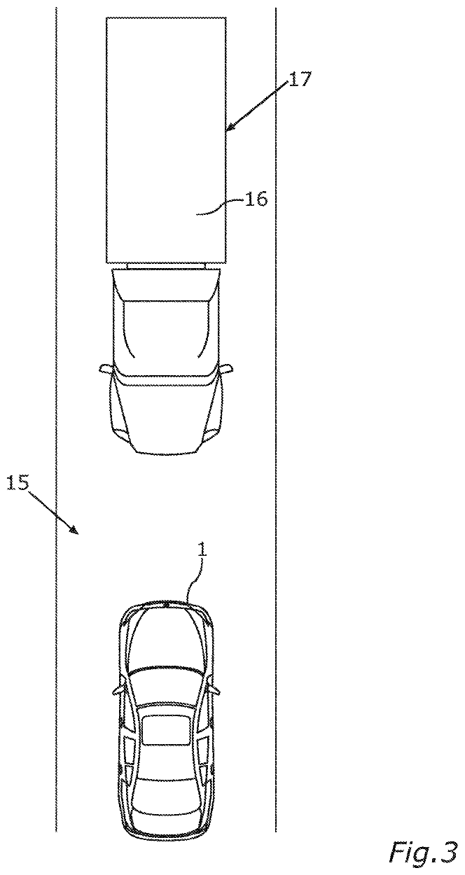

FIG. 3 shows the vehicle 1 in another traffic situation. Here too, the vehicle 1 is on a narrow road 15. On this road 15 there is moreover a truck 16 moving in the opposite direction of travel to the vehicle 1. The truck 16 represents another road user 17 in the surroundings 4 of the vehicle 1. Here too, the computing device 9 can be used to take the environmental data provided using the environment sensor 3 as a basis for detecting the dead-end situation and proactively offering or suggesting the reversing function to the driver of the vehicle 1.

This allows the reversing function or a so-called backtracking assist system to be used by the driver of the vehicle 1, even without prior knowledge about it. It is therefore possible for the reversing function to be actively offered or suggested to the driver of the vehicle 1 by the assistance system 2. It is also possible for the reversing function to be displayed only when a high level of benefit can be expected for the driver of the vehicle 1 and/or when the reversing function is actually needed by the driver of the vehicle 1.

1-10. (canceled)

11. A method for operating an assistance system of a vehicle, the method comprising:
recording a trajectory along which the vehicle has been maneuvered in a forward direction of travel manually by a driver;
receiving data that describe surroundings of the vehicle and/or a behavior of at least one other road user in the surroundings;
suggesting performance of a reversing function in which the vehicle is maneuvered along the recorded trajectory in a reverse direction of travel;
performing the reversing function by means of the assistance system in response to acceptance of the suggestion by the driver;
detecting a dead-end situation on a basis of the received data, the dead-end situation describing a situation in which passage of the vehicle is temporarily not possible and/or not permitted in the forward direction of travel; and
suggesting performance of the reversing function on a basis of the detected dead-end situation.

12. The method according to claim 11, comprising:
receiving the data that describe the surroundings of the vehicle as environmental data from at least one environment sensor of the vehicle.

13. The method according to claim 11,
wherein the received data that describe the surroundings of the vehicle are high-resolution map data.

14. The method according to claim 11,
wherein the data that describe a behavior of at least one other road user characterize a current driving maneuver and/or a driving intention of the at least one other road user.

15. The method according to claim 11,
wherein the data that describe a behavior of the at least one other road user include information relating to a driving maneuver performed by the at least one other road user in the past and/or a reversing function performed by the at least one other road user in the past.

16. The method according to claim 11, comprising:
characterizing a current behavior of the driver and suggesting performance of the reversing function additionally on a basis of the characterized behavior.

17. The method according to claim 11, comprising:
determining an individual driving ability of the driver on a basis of driving maneuvers manually performed by the driver to date, and suggesting performance of the reversing function additionally on a basis of the individual driving ability.

18. The method according to claim 11, comprising:
suggesting performance of the reversing function additionally on a basis of a usage of the reversing function by the driver to date.

19. An assistance system for a vehicle, wherein the assistance system is configured to:
record a trajectory along which the vehicle has been maneuvered in a forward direction of travel manually by a driver;
receive data that describe surroundings of the vehicle and/or a behavior of at least one other road user in the surroundings;
suggest performance of a reversing function in which the vehicle is maneuvered along the recorded trajectory in a reverse direction of travel;
perform the reversing function in response to acceptance of the suggestion by the driver;
detect a dead-end situation on a basis of the received data, the dead-end situation describing a situation in which passage of the vehicle is temporarily not possible and/or not permitted in the forward direction of travel; and
suggest performance of the reversing function on a basis of the detected dead-end situation.

20. The assistance system according to claim 19, wherein the assistance system is configured to:
receive the data that describe the surroundings of the vehicle as environmental data from at least one environment sensor of the vehicle.

21. The assistance system according to claim 19,
wherein the received data that describe the surroundings of the vehicle are high-resolution map data.

22. The assistance system according to claim 19,
wherein the data that describe a behavior of at least one other road user characterize a current driving maneuver and/or a driving intention of the at least one other road user.

23. The assistance system according to claim 19,
wherein the data that describe a behavior of the at least one other road user include information relating to a driving maneuver performed by the at least one other road user in the past and/or a reversing function performed by the at least one other road user in the past.

24. The assistance system according to claim 19, wherein the assistance system is configured to:
characterize a current behavior of the driver and suggesting performance of the reversing function additionally on a basis of the characterized behavior.

25. The assistance system according to claim 19, wherein the assistance system is configured to:
determine an individual driving ability of the driver on a basis of driving maneuvers manually performed by the driver to date, and suggesting performance of the reversing function additionally on a basis of the individual driving ability.

26. The assistance system according to claim 19, wherein the assistance system is configured to:
suggest performance of the reversing function additionally on a basis of a usage of the reversing function by the driver to date.

27. A vehicle comprising the assistance system according to claim 19.
